(19) United States
(12) Patent Application Publication
(10) Pub. No.: US 2003/0145151 A1
(43) Pub. Date: Jul. 31, 2003

(54) Nonvolatile memory and memory card

(75) Inventors: Toru Matsushita, Kokubunji (JP); Satoshi Noda, Ome (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 10/331,630

(22) Filed: Dec. 31, 2002

(30) Foreign Application Priority Data
Jan. 25, 2002 (JP) 2002-016465

(51) Int. Cl. G06F 12/00

(52) U.S. Cl. 711/5; 711/103

(57) ABSTRACT

The present invention provides a nonvolatile memory having a plurality of memory banks having a plurality of erasable and programmable nonvolatile memory cells and capable of memory operation independently respectively. The nonvolatile memory is capable of sequentially receiving write data and a write start command by the number of write processing regions after a write instruction command, a write start address and the number of the write processing regions with the write start address as a start point are inputted, latching write data for one write processing region in one memory bank and thereafter starting writing to each memory cell in response to the write start command, and making parallel a latch operation at one memory bank and writing to each memory cell at other memory banks.

### BACKGROUND OF THE INVENTION

This invention relates to a nonvolatile memory having a plurality of memory banks and a memory card equipped with the nonvolatile memory, and to a technology effective for application to a flash memory, for example.

A flash memory makes a difference in threshold voltage of each memory cell transistor according to the injection of electrons into a floating gate thereof or pulling-out thereof, for example, to thereby make it possible to store information therein. In the present specification, a state in which the threshold voltage of the memory cell transistor is low, is called an “erase state”, and a state in which the threshold voltage thereof is high, is called a “write state”, respectively. When information is stored according to write data, a high voltage is applied to a memory cell transistor held in the erase state in accordance with a logical value of write data. When the information is erased, a high voltage is applied thereto in a direction opposite to the writing. A relatively long processing time is required to obtain a desired threshold voltage at each memory cell transistor.

In the flash memory, the writing of data is performed in sector units like 2048 bytes. Write data are inputted plural times in parts every bytes, for example, from outside through an external interface circuit. Data writing to each memory cell is performed based on the input write data.

### SUMMARY OF THE INVENTION

When write and read operations are continuously effected on a plurality of sectors, the conventional flash memory must repeatedly utilize a write command or the like with the upper limit of a data size on which writing or the like can be effected at a time, being defined as a sector size. A normally-treated file size ranges from several tens of kilobytes to a few megabytes. This is divided into sector units of about 2 Kbytes, which are continuously accessed using multiple commands. In the case of writing, a time interval equivalent to a few times to a few tens times the time required to input data corresponding to one sector is required from the input of data corresponding to one sector to the flash memory to the completion of writing to each memory cell (write wait time). The write wait time is produced for each command. In the case of reading, a time interval equivalent to about one-half the time required to output data corresponding to one sector is taken until data reading is allowed since the input of a read instruction command corresponding to one sector to the flash memory (read wait time). In a similar to the writing, the read wait time is also made for each command. In a similar to the writing even in the case of erasure, an erase wait time is made for each command. Thus, when a large-capacity file extending over the plurality of sectors described above is accessed, there is a need to input multiple sector access commands and a write (read or erase) wait time is developed for each sector access, whereby throughput is not enhanced.

An object of the present invention is to provide a nonvolatile memory capable of making data access of a relatively large size efficient.

Another object of the present invention is to provide a nonvolatile memory capable of enhancing sequential access performance where data of a size larger than a sector size corresponding to a write unit of a memory bank is processed.

A further object of the present invention is to provide a memory card high in sequential access performance.

A still further object of the present invention is to provide a nonvolatile memory capable of realizing the speeding up of both data access of a size smaller than a sector size and data access of a size larger than the sector size, and a memory card.

The above, other objects, and novel features of the present invention will become apparent from the description of the present specification and the accompanying drawings.

Summaries of typical ones of the inventions disclosed in the present application will be described in brief as follows:

[1] Attention will be given to a write operation of a nonvolatile memory. The nonvolatile memory having a plurality of memory banks including a plurality of erasable and programmable nonvolatile memory cells and capable of access-processing independently respectively has a first write operation mode wherein a write instruction command, a write start address and the number of write processing regions with the write start address as a start point are inputted and thereafter write data and a write start command are capable of being sequentially accepted by the number of the write processing regions; writing to each memory cell is started in response to the write start command since the latching of write data for one write processing region in one memory bank; and a latch operation at one memory bank and writing to each memory cell at other memory banks are made parallelable.

Upon execution of sequential access (serial access) to a plurality of write processing regions according to access commands with the one write instruction command as the head, the operation of latching write data at one memory bank and writing to each memory cell at other memory banks are made parallel, whereby sequential write access performance is enhanced.

A second write operation mode may be adopted as an alternative to the first write operation mode. This is because the above writing to each memory cell in the first write operation mode is transitioned automatically to a process for writing to each memory cell in cooperation with the completion of a write-data latching operation without adopting means for starting the writing to the memory cell in response to a write start command.

As one desirable form of the present invention, the nonvolatile memory may have a second write operation mode in which write data is inputted after the input of a write instruction command and a write start address for one memory bank, and writing to each memory cell can be started after write data has been latched in a write processing region designated by the write start address. In brief, write access commands in sector units may be utilized in combination which make use of write data with sector sizes adopted for the prior art as limits. If the number of write processing regions in the first write operation mode or the second write operation mode is “1”, it is then substantially identical to a third write operation mode. However, if the third write operation mode is used at this time, then information for designating or specifying the number of write processing regions becomes unnecessary and hence the amount of data for each access command can be reduced.

A command code of a write instruction command may be made different between the first write operation mode (second write operation mode) and the third write operation mode. In brief, a command code of the first write operation mode (second write operation mode) is newly added to the conventional third write operation mode.

The same command code may be adopted for the write instruction command of the first write operation mode (second write operation mode) and the write instruction command of the third write operation mode. In this case, instructing means for giving instructions as to interpretation switching to the same command codes is provided. The write instruction command may be interpreted as instructions for the first write operation mode (second write operation mode) in a first state of the instructing means, and the write instruction command may be interpreted as instructions for a third write operation mode in a second state of the instructing means.

As one desirable form of the present invention, the memory banks respectively have sets of sectors each comprising nonvolatile memory cell columns. Sector addresses are respectively assigned to the respective sectors, and the adjacent sector addresses are placed in their corresponding mutually-different memory banks. At this time, the write start address corresponds to the sector address of each memory bank, and the number of the write processing regions corresponds to the number of sectors. Thus, control for making parallel both data latch and writing to each memory cell with respect to the sectors of the continuous sector addresses becomes easy. In other words, a memory controller for access-controlling the nonvolatile memory need not to determine the relationship between each sector address intended for writing and a free or space memory bank as the occasion arises. In brief, the nonvolatile memory per se will support easing of sequential access control on a plurality of sectors.

[2] Attention will be made to a read operation of a nonvolatile memory. The nonvolatile memory comprising a plurality of memory banks having a plurality of erasable and programmable nonvolatile memory cells and capable of access-processing independently respectively has a first read operation mode wherein a read instruction command, a read start address and the number of read processing regions with the read start address as a start point are inputted and thereafter data can be read from the plurality of memory banks by the number of the read processing regions and outputted to the outside; an external output is started since the latching of data read from each memory cell for one read processing region in the corresponding memory bank; and a read and latch operation of data at one memory bank and the output of latch data to the outside at other memory banks can be made parallel.

Upon execution of sequential access to a plurality of read processing regions according to access commands with the one read instruction command as the head, the operation of reading and latching data at one memory bank and the output of latch data to the outside at other memory banks are made parallel, whereby sequential read access performance is enhanced.

As a desirable form of the present invention, the nonvolatile memory may have a second read operation mode wherein after a read instruction command and a read start address for one memory bank have been inputted, data read from the corresponding read processing region designated by the read start address is capable of being latched and outputted to the outside. In brief, read access commands in sector units may be utilized in combination which effect data reading with sector sizes adopted for the prior art as limits.

A command code of a read instruction command may be made different between the first read operation mode and the second read operation mode. In brief, a command code of the first read operation mode is newly added to the conventional second read operation mode.

The same command codes may be adopted for the read instruction command of the first read operation mode and the read instruction command of the second read operation mode. In this case, instructing means for giving instructions as to interpretation switching to the same command codes is provided. Further, the read instruction command may be interpreted as instructions for the first read operation mode in a first state of the instructing means, and the read instruction command may be interpreted as instructions for the second read operation mode in a second state of the instructing means.

As one desirable form of the present invention, the allocation of the memory banks, sectors and sector addresses may preferably be set identical to the above. At this time, the read start address corresponds to the sector address, and the number of the read processing regions corresponds to the number of the sectors.

[3] Attention will be made to an erase operation of a nonvolatile memory. The nonvolatile memory comprising a plurality of memory banks having a plurality of erasable and programmable nonvolatile memory cells and capable of access-processing independently respectively has a first erase operation mode in which an erase instruction command, an erase start address, and the number of erase processing regions with the erase start address as a start point are inputted and thereafter erase processing regions of the plurality of memory banks can be erased by the number of the erase processing regions; and an erase operation for the erase processing region at one memory bank and an erase operation for each erase processing region at other memory banks can be made parallel.

Upon execution of sequential access to a plurality of erase processing regions according to access commands with the one erase instruction command as the head, the operation of erasing for the corresponding erase processing region at one memory bank and the operation of erasing for each erase processing region at other memory banks are made parallel, whereby sequential erase access performance is enhanced. When one memory bank is capable of erasing in one sector unit, for example, a plurality of memory banks are made parallel up to the designated number of erase sectors, so that erase operations of sector units can be performed.

As a desirable form of the present invention, the nonvolatile memory may have a second erase operation mode wherein after an erase instruction command and sector addresses for one memory bank have been inputted, erasing is effected on each memory cell of a sector designated by the corresponding sector address. In brief, erase access commands in sector units may be utilized in combination which effect erasing with one sector adopted for the prior art as a limit.

As one form of the present invention, a command code of an erase instruction command may be made different between the first erase operation mode and the second erase operation mode. In brief, a command code of the first erase operation mode is newly added to the conventional second erase operation mode.

As another form of the present invention, the same command codes may be adopted for the erase instruction command of the first erase operation mode and the erase instruction command of the second erase operation mode. In this case, instructing means for giving instructions as to interpretation switching to the same command codes is provided. Further, the erase instruction command may be interpreted as instructions for the first erase operation mode in a first state of the instructing means, and the erase instruction command may be interpreted as instructions for the second erase operation mode in a second state of the instructing means.

As one desirable form of the present invention, the allocation of the memory banks, sectors and sector addresses may preferably be set identical to the above. At this time, the erase start address corresponds to the sector address of each memory bank, and the number of the erase processing regions corresponds to the number of the sectors.

[4] Attention will be made to a write operation of a memory card. The memory card has a nonvolatile memory having a plurality of memory banks capable of access-processing independently respectively, and a memory controller capable of access-controlling the nonvolatile memory, both of which are provided on a card substrate. The memory controller is capable of outputting write data and a write start command by the number of write processing regions following a first write instruction command, a write start address and the number of the write processing regions with the write start address as a start point. The nonvolatile memory latches write data for one write processing region in one memory bank in response to the first write instruction command and thereafter starts writing thereof to each memory cell in response to the write start command, and makes parallel a latch operation at one memory bank and writing to each memory cell at other memory banks.

Owing to the issue of access commands with one write instruction command as the head by the memory controller, the nonvolatile memory is capable of making parallel the operation of latching write data at one memory bank and writing to each memory cell at other memory banks upon sequential access to a plurality of write processing regions. Consequently, sequential write access performance is enhanced.

A second write instruction command may be adopted as an alternative to the first write instruction command. As an alternative to the issue of the write start command by the memory controller, the nonvolatile memory may take a write process to each memory cell automatically transitioned in cooperation with the completion of a write-data latching operation.

As one specific form of the present invention, a third write instruction command for sector unit-based write access may be utilized in combination which makes use of write data with each sector size adopted for the prior art as a limit. In this case, the memory controller is capable of outputting a third write instruction command, a write start address, and write data. The nonvolatile memory latches write data for a write processing region designated by the write start address in response to the third write instruction command and thereafter starts writing thereof to each memory cell.

As another specific form of the present invention, command interpretation logic for the same command codes may be switched so that a first write instruction command (second write instruction command) functions even as the third write instruction command. Namely, the memory controller is further capable of outputting a first write instruction command (second write instruction command), a write start address, and write data as one access command. At this time, the nonvolatile memory inputs command interpretation-switching information, and latches write data for the corresponding write processing region designated by the write start address in response to the first write instruction command (second write instruction command) in a first state of the command interpretation-switching information and thereafter starts writing thereof to each memory cell. Further, the nonvolatile memory latches write data for one write processing region in one memory bank in response to the first write instruction command (second write instruction command) in a second state of the command interpretation-switching information and thereafter starts writing thereof to each memory cell in response to the write start command, and makes parallel a latch operation at one memory bank and writing to each memory cell at other memory banks.

[5] Attention will be given to a read operation of a memory card. The memory card has a nonvolatile memory having a plurality of memory banks capable of access-processing independently respectively, and a memory controller capable of access-controlling the nonvolatile memory, both of which are provided on a card substrate. The memory controller is capable of outputting a first read instruction command, a read start address and the number of read processing regions with the read start address as a start point. The nonvolatile memory is capable of reading data from the plurality of memory banks by the number of the read processing regions in response to the first read instruction command and outputting the same to the outside. Further, the nonvolatile memory latches data read from the corresponding memory cell for one read processing region at the corresponding memory bank and thereafter starts an external output thereof, and makes parallel the operation of reading and latching data at one memory bank, and the external output of latch data at other memory banks.

Owing to the issue of access commands with one read instruction command as the head by the memory controller, the nonvolatile memory is capable of making parallel the operation of latching read data at one memory bank and the operation of outputting latch data to the outside at other memory banks upon sequential access to a plurality of read processing regions. Consequently, sequential read access performance is enhanced.

As one specific form of the present invention, a second read instruction command for sector unit-based read access may be utilized in combination which effects reading with each sector size adopted for the prior art as a limit. In this case, the memory controller is capable of outputting a second read instruction command, and a read start address. The nonvolatile memory latches data read from a read processing region designated by the read start address in response to the second read instruction command and thereafter outputs the same to the outside.

As another specific form of the present invention, command interpretation logic for the same command codes may be switched such that a first read instruction command functions even as the second read instruction command. Namely, the memory controller is further capable of outputting a first read instruction command and a read start address. At this time, the nonvolatile memory inputs command interpretation-switching information, and latches data read from the corresponding read processing region designated by the read start address in response to the first read instruction command in a first state of the command interpretation-switching information and thereafter starts the output thereof to the outside, and latches data read from each memory cell for one read processing region at the corresponding memory bank in response to the first read instruction command in a second state of the command interpretation-switching information and thereafter starts the output thereof to the outside, and makes parallel the operation of reading and latching data at one memory bank and the output of latch data at other memory banks to the outside.

[6] Attention will be made to an erase operation of a memory card. The memory card has a nonvolatile memory having a plurality of memory banks capable of access-processing independently respectively, and a memory controller capable of access-controlling the nonvolatile memory, both of which are provided on a card substrate. The memory controller is capable of outputting a first erase instruction command, an erase start address and the number of erase processing regions with the erase start address as a start point. The nonvolatile memory is capable of erasing erase processing regions for the plurality of memory banks by the number of the erase processing regions in response to the first erase instruction command, and makes parallel an erase operation for the corresponding erase processing region at one memory bank, and an erase operation for erase processing regions at other memory banks.

Owing to the issue of one access command with the erase instruction command as the head by the memory controller, the nonvolatile memory is capable of making parallel the operation of erasing at one memory bank and the operation of erasing at a plurality of memory banks upon sequential access to a plurality of read processing regions. Consequently, sequential erase performance is enhanced.

As one specific form of the present invention, a second erase instruction command for sector unit-based erase access may be utilized in combination which effects erasing with each sector size adopted for the prior art as a limit. In this case, the memory controller is capable of outputting a second erase instruction command and an erase start address as one access command. The nonvolatile memory effects erasing on each memory cell for the corresponding erase processing region designated by the erase start address in response to the second erase instruction command.

As another specific form of the present invention, command interpretation logic for the same command codes may be switched so that a first erase instruction command functions even as the second erase instruction command. Namely, the memory controller is capable of outputting a first erase instruction command and an erase start address. The nonvolatile memory inputs command interpretation-switching information and effects erasing on each memory cell for the corresponding erase processing region designated by the erase start address in response to the first erase instruction command in a first state of the command interpretation-switching information. The nonvolatile memory is capable of erasing erase processing regions of the plurality of memory banks by the number of the erase processing regions in response to the first erase instruction command in a second state of the command interpretation-switching information, and makes parallel an erase operation for the corresponding erase processing region at one memory bank and an erase operation for the corresponding erase processing region at other memory banks.

[7] Attention will be given to a rewrite command for a nonvolatile memory. The nonvolatile memory is capable of sequentially accepting write data and a write start command by the number of rewrite processing regions after a rewrite instruction command, a rewrite start address and the number of the rewrite processing regions with the rewrite start address as a start point are inputted, and latches write data for one erased write processing region in one memory bank and thereafter starting writing thereof to each memory cell in response to the write start command, and making parallel a latch operation at one memory bank and writing to each memory cell at other memory banks.

As an alternative to the write start command, the start of writing to each memory cell at one memory bank may be synchronized with the completion of the operation of latching write data for one write processing region as its trigger.

### BRIEF DESCRIPTION OF THE DRAWINGS

FIG. 1 is a block diagram illustrating the whole of a flash memory according to the present invention;

FIG. 2 is a vertical sectional view illustrating a structure of a nonvolatile memory;

FIG. 3 is a circuit diagram illustrating an AND type memory cell array;

FIG. 4 is an explanatory view illustrating voltage-applied states at erase and write operations;

FIG. 5 is an explanatory view showing an example of mapping of sector addresses in a plurality of memory banks;

FIG. 6 is an explanatory view illustrating a single read access flow for one memory bank;

FIG. 7 is an explanatory view illustrating a single erase access flow for one memory bank;

FIG. 8 is an explanatory view illustrating a single write access flow for one memory bank;

FIG. 9 is an explanatory view illustrating a sequential read access flow;

FIG. 10 is an explanatory view illustrating a sequential erase access flow;

FIG. 11 is an explanatory view illustrating a sequential write access flow;

FIG. 12 is an explanatory view showing another example of the sequential write access flow;

FIG. 13 is an explanatory view illustrating a sequential rewrite access flow;

FIG. 14 is an explanatory view showing another example of the sequential rewrite access flow;

FIG. 15 is a block diagram illustrating a memory card which has focused attention on a command-interpretation switching configuration where a flash memory wherein different command codes are respectively assigned to a single access command and a sequential access command, is used;

FIG. 16 is a block diagram illustrating a memory card which has focused attention on a command-interpretation switching configuration where a flash memory wherein the same command code is assigned to a single access command and a sequential access command, is used;

FIG. 17 is a block diagram illustrating another memory card which has focused attention on a command-interpretation switching configuration where a flash memory wherein the same command code is assigned to a single access command and a sequential access command, is used; and

FIG. 18 is a block diagram illustrating a further memory card which has focused attention on a command-interpretation switching configuration where a flash memory wherein the same command code is assigned to a single access command and a sequential access command, is used.

### DETAILED DESCRIPTION OF THE PREFERRED EMBODIMENTS

<<Overall Configuration of Flash Memory>>

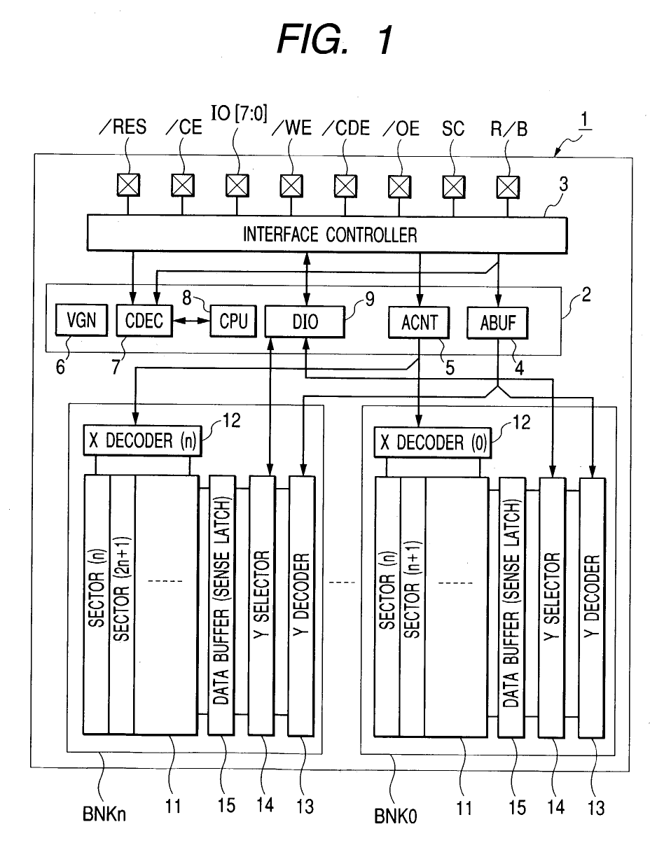

One embodiment of a flash memory 1 according to the present invention is shown overall in FIG. 1.

The flash memory 1 includes a plural, e.g., n+1 memory banks BNK0 through BNKn capable of performing memory operations independently respectively, a control unit 2 for controlling the memory operations with respect to the memory banks BNK0 through BNKn, and an interface controller 3 which interfaces with the outside, which are provided on one semiconductor substrate (semiconductor chip) like monocrystalline silicon. The control unit 2 has an address buffer (ABUF) 4, an address counter (ACNT) 5, an internal power supply circuit (VGN) 6, a command decoder (CDEC) 7, a central processing unit and its operating program (CPU) 8, and a data input/output control logic circuit (DIO) 9. The following description will be made under n=3 and the provision of four memories for convenience.

An input/output terminal I/O [7:0] used as a group, of the flash memory 1 is shared for an address input, a data input/output and a command input. An X address signal (sector address signal) inputted from the input/output terminal I/O [7:0] is supplied to the address buffer 4 through the interface controller 3. An input Y address signal is preset to the Y address counter 5 through the interface controller 3. If the Y address signal is not supplied, then the Y address counter 5 maintains a reset stage of an initial value. A command inputted from the input/output terminal I/O [7:0] is supplied to the command decoder 7 through the interface controller 3. Write data for each memory bank, which is inputted from the input/output terminal I/O [7:0], is supplied to the data input/output control circuit 9 through the interface controller 3 and supplied to the corresponding memory bank intended for writing in 8-bit units. Read data sent from the corresponding memory bank is supplied from the data input/output control circuit 9 to the input/output terminal I/O [7:0] through the interface controller 3. Incidentally, signals inputted/outputted from the input/output terminal I/O [7:0] are also called signals I/O [7:0] for convenience.

The interface controller 3 receives or inputs therein as access control signals, a chip enable signal /CE, an output enable signal /OE, a write enable signal /WE, a serial clock signal SC, a reset signal /RES, and a command enable signal /CDE. Signs / marked immediately before their signal names mean that the corresponding signals are low/enable. The interface controller 3 controls signal interfacing functions to the outside, etc. according to the states of their signals.

The memory banks BNK0 through BNKn respectively have a large number of storage information rewritable nonvolatile memory cells. The X address signal for selecting the corresponding nonvolatile memory cell from each individual memory bank is outputted from the address buffer 4, whereas the Y address signal for selecting the corresponding nonvolatile memory cell from each individual memory bank is outputted from the address counter 5.

Although not restricted in particular, the memory banks BNK0 through BNKn respectively have memory cell arrays 11, X decoders 12, Y decoders 13, Y selectors 14, and data buffers (sense latches) 15, etc. The memory cell array 11 has a large number of electrically erasable and programmable nonvolatile memory cells.

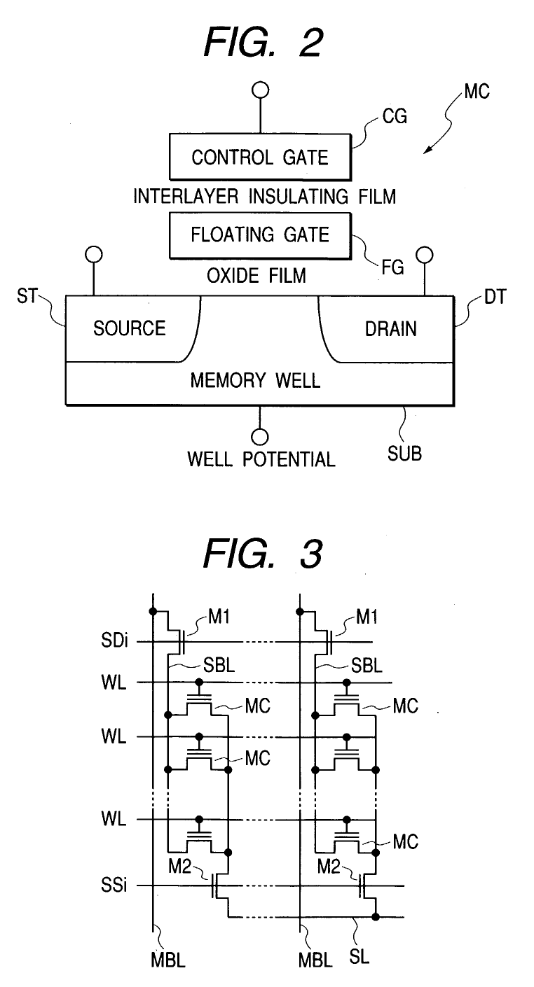

A nonvolatile memory cell MC is configured so as to have a source ST and a drain DT formed in a semiconductor substrate or a memory well SUB, a floating gate FG formed in a channel region through an oxide film, and a control gate CG superposed on the floating gate FG with an interlayer insulating film interposed therebetween, as illustrated in FIG. 2 by way of example.

When the memory cell array 11 is of an AND type array illustrated in FIG. 3, a typically-illustrated sub bit line SBL is connected to a main bit line MBL through each select MOS transistor M1. The drains of nonvolatile memory cells MCs are coupled to their corresponding sub bit line SBL. The sources of the nonvolatile memory cells MCs, which share the use of the sub bit line SBL, are commonly connected to a source line SL through a second select MOS transistor M2. The first select MOS transistors M1 are switch-controlled by a bit line control line SDi in row-direction units, whereas the second select MOS transistors M2 are switch-controlled by a source line control line SSi in the row-direction units. As illustrated in FIG. 1, the memory cell arrays 11 are respectively configured as a set of a plurality of sectors. Although not restricted in particular, the sector is configured as a set of memory cells corresponding to 2048 bytes, which shares the use of each word line.

Main bit lines corresponding to 2048 bytes are connected to the corresponding data buffer 15. The data buffer 15 has 2048 sense latches (sense latch arrays) corresponding to the respective main bit lines, and 2048 data latches (data latch arrays). The main bit lines are respectively selectively connectable to the data latch arrays and the sense latch arrays.

The X decoder 12 decodes an X address signal and thereby selects the corresponding word line WL, the bit line control line SDi and the source line control line SSi illustrated in FIG. 3 in accordance with a designated or specified memory operation. The Y decoder 13 decodes a Y address signal outputted from the address counter 5 to select the corresponding bit-line selecting Y selector 14 in byte units.

The Y selector 14 makes the corresponding sense latch array or data latch array of the data buffer 15 conductive to the data input/output control circuit 9. Thus, if the address counter 5 is sequentially incremented from an initial value, then the sense latch arrays or data latch arrays of the data buffer 15 are sequentially selected from the lowest order to the highest order in 8-bit units through the Y decoder 13 and the Y selector 14.

Upon a read operation, memory information corresponding to one sector (2048 bytes) at which select terminals are connected to one word line selected, is latched in the corresponding sense latch array of the data buffer 15. The latched memory information is outputted from the input/output terminal I/O [7:0] through the data input/output control circuit 9 in 8-bit units selected by the corresponding Y decoder 13 and Y selector 14.

Upon a write operation, data of the corresponding sector intended for writing is latched in the corresponding sense latch array of each data buffer 15. Write data is inputted from the input/output terminal I/O [7:0] in 8-bit units and latched in the corresponding data latch array of each data buffer 15 selected by the Y selector 14. The read data of each sector latched in the corresponding sense latch array on the data buffer 15 and the write data latched in the corresponding data latch array are added or ORed within the data buffer 15. A write operation for each sector intended for writing is performed based on the result of data addition or ORing. When data corresponding to one sector is written, the beginning to the end of the data buffer may be filled with the write data. Accordingly, the ORing of the sense latch array and the data latch array becomes unnecessary substantially in this case, and the writing may be performed using the write data of the data latch array. When the corresponding sector is partly rewritten, write data is retained in only part of the data buffer 15, corresponding to a portion intended for rewriting of part of the sector, and writeback of the sector may be performed in this condition.

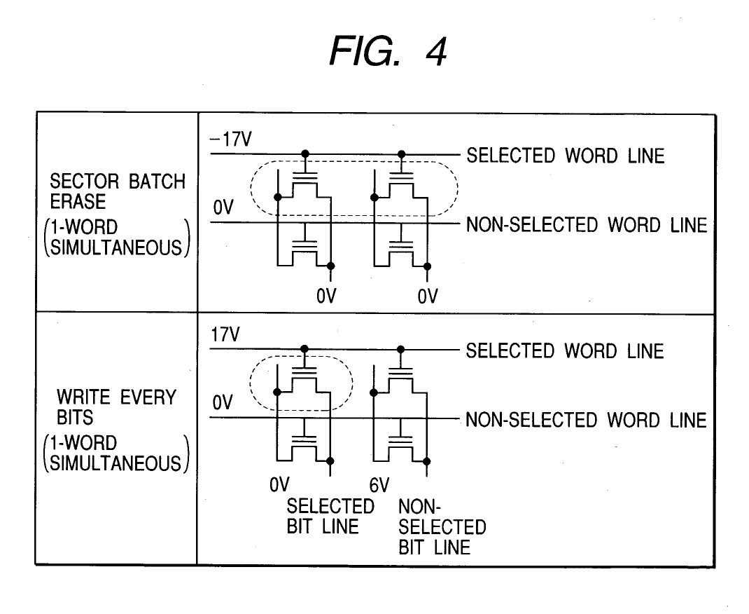

An erase operation for the flash memory is handled as a batch erasure in word-line units (also corresponding to one-sector units) as illustrated in FIG. 4. −17V is applied to a selected word line, 0V is applied to a non-selected word line, and 0V is applied to source lines.

Upon writing for the memory cells, 17V is applied to a write selected word line, 0V is applied to a write selected bit line, and 6V is applied to a write non-selected bit line as illustrated in FIG. 4. As the write high-voltage apply-time increases, the threshold voltage of each memory cell rises. Whether 0V is applied to the bit line or 6V is applied to the bit line, is determined by a logic value of a signal indicative of ORing of data latched in the corresponding sense latch array and data latched in the corresponding data latch array.

Upon a read operation for the memory cells, although not restricted in particular, a read selected word line is set to 3.2V, a source line is made conductive to a circuit's ground voltage, 1.0V is applied to its corresponding bit line through a sense latch circuit, whereby memory information is read according to a change in the potential of the bit line due to the presence or absence of a current that flows from the bit line to the source line according to the threshold voltage of each memory cell.

The internal power supply circuit 6 generates various operating power supplies used for write, erase, verify, read, etc. and supply them to the memory banks BNK0 through BNKn.

The command decoder 7 and the CPU 8 control on the whole, memory operations such as writing to each multibank, etc. according to an access command and the like supplied from the interface controller 3. Although not restricted in particular, the access command contains a singular command code or plural command codes, address information necessary for execution of each command, and data information or the like according to predetermined formats.

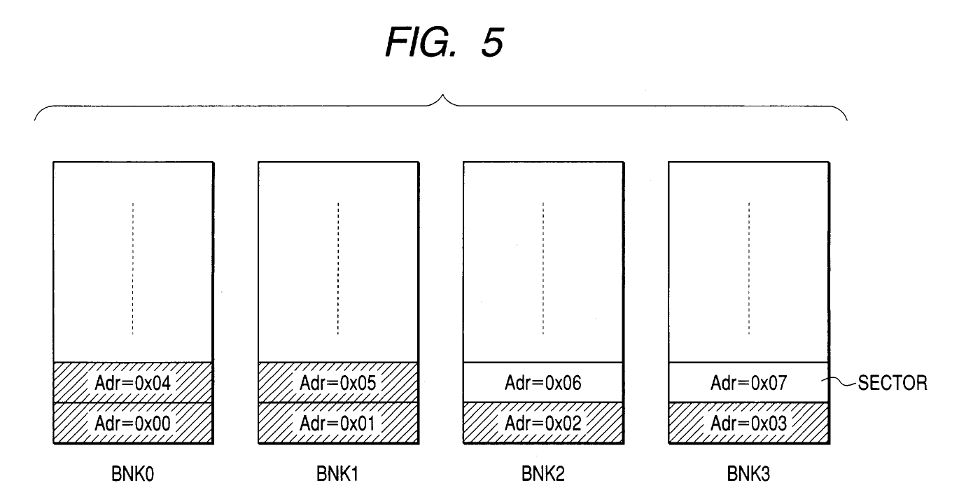

An example of mapping of sector addresses of the memory banks BNK0 through BNK3 is illustrated in FIG. 5. The sector addresses are addresses set in sector units, and the adjacent sector addresses are disposed in their corresponding memory banks different from one another. For instance, a sector address Adr=0x00, a next sector address Adr=0x01, a further next sector address Adr=0x02, a still further next sector address Adr=0x03, and a still further next sector address Adr=0x04 are respectively mapped in the order of BNK0, BNK1 adjacent to BNK0, BNK2 adjacent to BNK1, BNK3 adjacent to BNK2, and BNK0 returned to the start.

<<Single Access Command>>

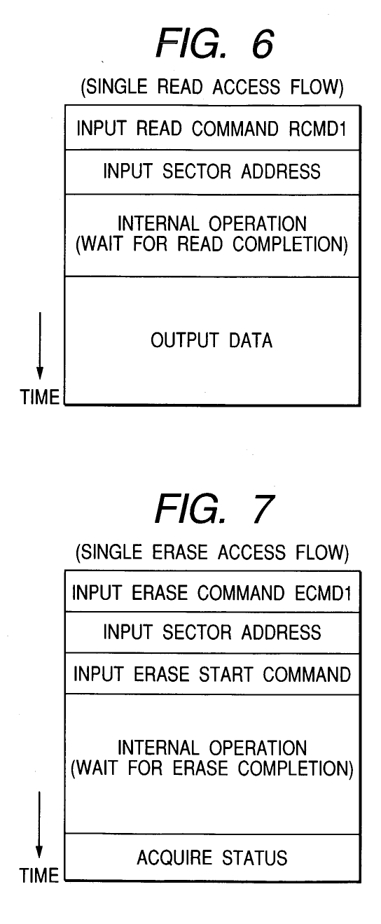

A single read access flow for one memory bank is illustrated in FIG. 6. A single read access command is made up of a read command RCMD1 and a sector address. When an access subject such as a memory controller issues a read access command to the flash memory 1, the flash memory 1 performs an internal operation for reading memory information for the designated sector from the corresponding memory cell and latching the same in the data buffer 15 and carries out an output operation for sequentially outputting the latched data to the outside in 8-bit units.

When it is desired to sequentially perform read access to a plurality of sectors, single read access commands may be issued on a serial basis. This is similar even when successive sector addresses are read. It is necessary to designate or specify a read command RCMD1 and a sector address as occasion arises. When the sectors lying in the same memory bank are continuously read, it is necessary to carry out a procedure for issuing the next single read access command in wait for the completion of execution of one single read access command.

A single erase access flow for one memory bank is illustrated in FIG. 7. The single erase access command comprises an erase command ECMD1, a sector address, and an erase start command. When the access subject issues an erase access command to the flash memory 1, the flash memory 1 performs an internal operation for erasing memory information of each designated sector. The completion of the erase operation can be detected based on the status.

When it is desired to erase a plurality of sectors, single erase access commands may be issued on a serial basis. This is similar even when successive sector addresses are erased. It is necessary to designate or specify an erase command ECMD1, a sector address and an erase start command as occasion arises. There may be a case in which a procedure for issuing the next single erase access command in wait for the completion of execution of one single erase access command is needed.

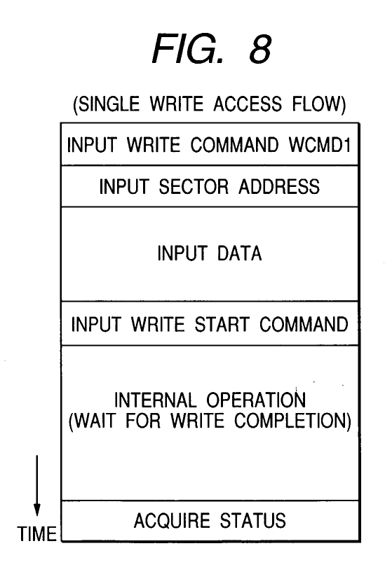

A single write access flow for one memory bank is illustrated in FIG. 8. The single write access command comprises a write command WCMD1, a sector address, write data and a write start command. When the access subject issues a write access command to the flash memory 1, the flash memory 1 stores write data in the corresponding data buffer 15 of the memory bank intended for access and thereafter performs writing to each memory cell in the designated sector. The completion of the write operation can be detected based on the status.

When it is desired to perform writing of file data or the like lying over a plurality of sectors, single write access commands may be issued on a serial basis. This is similar even when it is desired to perform writing to continuous sector addresses. It is necessary to designate a write command WCMD1 and a sector address or the like as occasion arises. There may be a case in which a procedure for issuing the next access command in wait for the completion of execution of one access command is needed.

<<Sequential Read Access Command>>

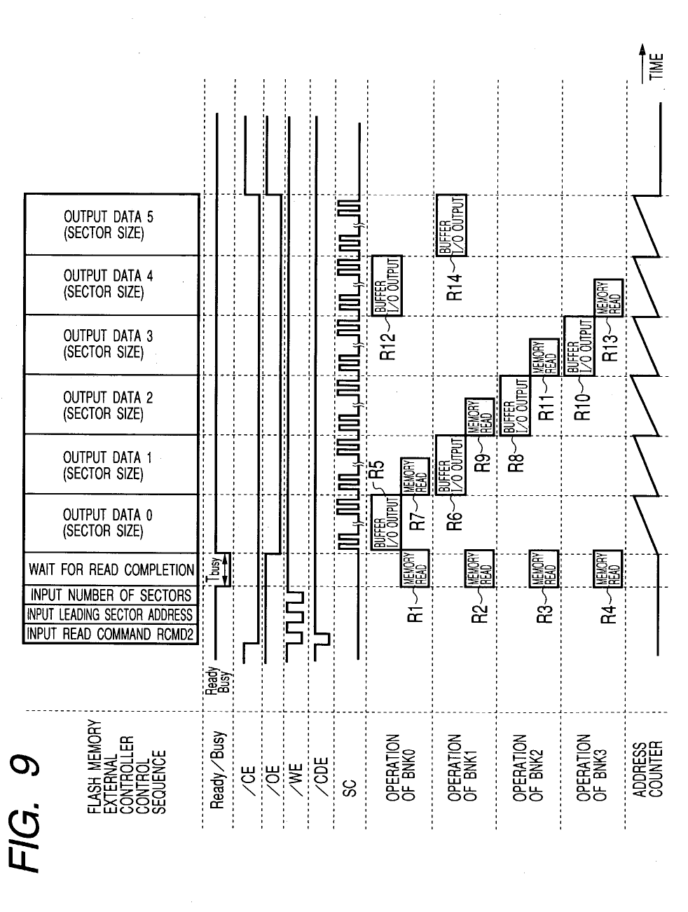

A sequential read access flow is illustrated in FIG. 9. A sequential read access command is made up of a read command RCMD2, a leading sector address and the number of sectors. FIG. 9 shows, as one example, a case in which the designated leading sector address is represented as Adr=0x00 in FIG. 5, the designated number of sectors is set as 6, and the six sectors shown in FIG. 5 are intended for access.

When the access subject (e.g., memory controller) issues a sequential read access command to the flash memory 1, the flash memory 1 decodes the command to select four sectors (corresponding to the number of memory banks, i.e., four) from the leading sector address, reads memory information (data 0 to 3) of sectors at the respective memory banks BNK0 through BNK3 and latches them in their corresponding sense latch arrays (R1 through R4). When the time Tbusy required to carry out this operation has elapsed, a memory bank having a sector designated by the leading sector address (Adr=0x00), e.g., the memory bank BNK0 sequentially outputs read information (data 0) latched in the corresponding sense latch array to the outside (R5). This output operation is performed by selecting the read information in 8-bit units by means of the Y selector 14 while the address counter 5 is being sequentially incremented from the initial value.

When the operation of outputting the data 0 is completed, the memory bank BNK1 having the next sector (Adr=0x01) sequentially outputs read information (data 1) latched in the corresponding sense latch array to the outside at a process R2 (R6). In parallel with it, the memory bank BNK0 having completed the output of the read information to the outside reads memory information (data 4) from a sector address Adr=0x04 in advance and latches the information in the corresponding sense latch array (R7).

When the operation of outputting the data 1 is completed, the memory bank BNK2 having the next sector (Adr=0x02) sequentially outputs read information (data 2) latched in the corresponding sense latch array to the outside at a process R3 (R8). In parallel with it, the memory bank BNK1 having completed the output of the read information to the outside reads memory information (data 5) from a sector address Adr=0x05 in advance and latches the information in the corresponding sense latch array (R9).

When the operation of outputting the data 2 is completed, the memory bank BNK3 having the next sector (Adr=0x03) sequentially outputs read information (data 3) latched in the corresponding sense latch array to the outside at a process R4 (R10). In parallel with it, the memory bank BNK2 having completed the output of the read information to the outside reads memory information (data 6) from a sector address Adr=0x06 in advance and latches the information in the corresponding sense latch array (R11).

When the operation of outputting the data 3 is completed, the memory bank BNK0 having the next sector (Adr=0x04) sequentially outputs read information (data 4) latched in the corresponding sense latch array to the outside at a process R7 (R12). In parallel with it, the memory bank BNK3 having completed the output of the read information to the outside reads memory information (data 7) from a sector address Adr=0x07 in advance and latches the information in the corresponding sense latch array (R13).

When the operation of outputting the data 4 is completed, the memory bank BNK1 having an access final sector (Adr=0x05) sequentially outputs read information (data 5) latched in the corresponding sense latch array to the outside at a process R9 (R14). Since the external output process of the access final sector is a final process, a read process executed in parallel with it is restrained. Since the processes R11 and R13 are also unnecessary processes substantially in this sense, their execution may be restrained. In such a case, a control procedure for restraining a memory information read latch process parallel with an external output operation for a sector two ahead of the external output operation for the final sector since the external output operation may be adopted.

The CPU 8 performs, based on information about decoding by the command decoder 7, etc., the increment of each sector address with the leading sector address as a base or start point, and parallel control on both the operation of reading memory information from each sector for one memory bank and latching the same and the operation of outputting latch data for other memory banks to the outside.

Upon execution of sequential access to a plurality of sectors according to the sequential read access command having the read command RCMD2 at the head thereof, the operation of reading data from one memory bank and latching the same therein, and the output of data latched in other memory banks to the outside are executed in parallel, whereby sequential read access performance can be enhanced.

<<Sequential Erase Access Command>>

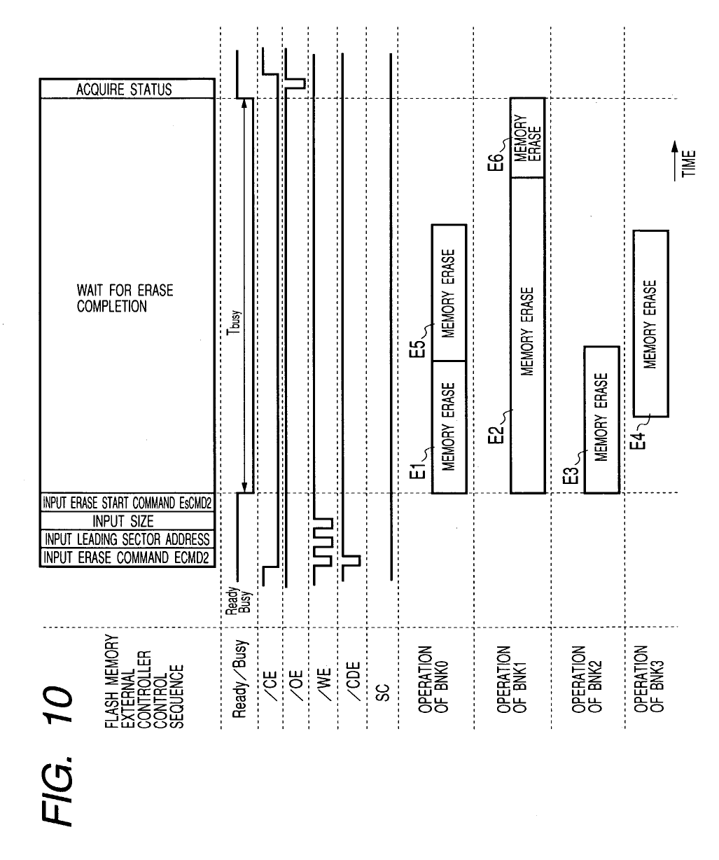

A sequential erase access flow is illustrated in FIG. 10. A sequential erase access command comprises an erase command ECMD2, a leading sector address, the number of sectors, and an erase start command EsCMD2. FIG. 10 shows, as one example, a case in which the designated leading sector address is represented as Adr=0x00 in FIG. 5, the designated number of sectors is set as 6, and the six sectors Adr=0x00 through 0x05 shown in FIG. 5 are intended for access.

When the access subject (e.g., memory controller) issues a sequential erase access command to the flash memory 1, the flash memory 1 decodes the command to select four sectors (corresponding to the number of memory banks, i.e., four) from the leading sector address and starts erase operations for objective sectors at the respective memory banks BNK0 through BNK3 (E1 through E4). Time intervals necessary for the erase operations are commonly different from one another every sectors. In brief, the characteristics of individual memory cells are not necessarily identical to one another, and the states of threshold voltages of the memory cells are not necessarily matched either. When the erasure of the sector Adr=0x00 previously intended for erasure is completed, the memory bank BNK0 starts an erase operation for the next sector Adr=0x04 (E5). When the erasure of the sector Adr=0x01 previously intended for erasure is completed, the memory bank BNK1 starts an erase operation for the next sector Adr=0x05 (E6). The memory controller is capable of detecting the completion of erasure for all the designated sectors, based on a ready/busy signal R/B or a ready/busy flag of a status register. The status register is provided for the interface controller 3 shown in FIG. 1 and capable of reading the ready/busy flag from a predetermined terminal of the external terminal I/O [7:0] in synchronism with a change to a low level of a signal /OE. The ready/busy flag is provided for each bank and brought to a ready state in a state being capable of accepting an external new process.

<<Sequential Write Access Command>>

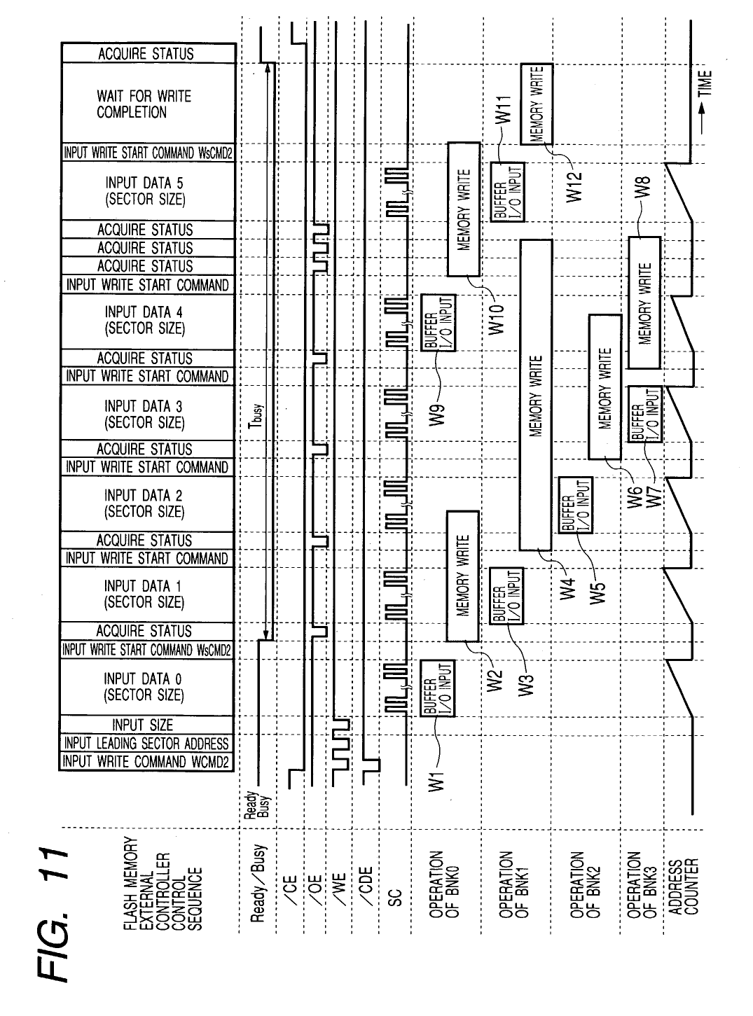

A sequential write access flow is illustrated in FIG. 11. A sequential write access command comprises a write command WCMD2, a leading sector address and the number of sectors, write data corresponding to the number of sectors, and a write start command WsCMD2. FIG. 11 shows, as one example, a case in which the designated leading sector address is represented as Adr=0x00 in FIG. 5, the designated number of sectors is set as 6, and the six sectors Adr=0x00 through 0x05 shown in FIG. 5 are intended for access.

When the access subject (e.g., memory controller) issues the write command WCMD2, the leading sector address and the number of sectors to the flash memory 1, the flash memory 1 decodes the command to select the operation of the memory bank BNK0 corresponding to the leading sector address Adr=0x00, inputs write data (data 0) supplied from the memory controller in byte units, and sequentially stores the same in the corresponding data latch arrays of the data buffer 15 through the Y selector 14 (W1). A column selecting operation corresponding to one sector obtained by an increment operation of the address counter 5 carries out the operation of selecting the Y selector 14 at this time.

When the write start command WsCMD2 is issued from the memory controller following the input operation of the data 0 by the process W1, the flash memory 1 decodes the command and starts the operation of writing the data 0 stored in each data latch array of the data buffer 15 at the process W1 into the corresponding sector of the leading address Adr=0x00 of the memory bank BNK0 (W2). In parallel with it, the memory controller determines a ready/busy state of the memory bank BNK1 having the next sector (Adr=0x01), based on the ready/busy flag. When the memory controller detects the ready state, it outputs write data 1 for the sector Adr=0x01 to the flash memory 1. The flash memory 1 selects the operation of the memory bank BNK1 corresponding to the next sector address Adr=0x01, inputs or receives the write data (data 1) supplied from the memory controller in byte units, and sequentially stores the same in each individual data latch array of the data buffer 15 through the Y selector 14 (W3).

When the write start command WsCMD2 is issued from the memory controller following the input operation of the data 1 by the process W3, the flash memory 1 decodes the command and starts the operation of writing the data 1 stored in the corresponding data latch array of the data buffer 15 at the process W3 into the corresponding sector of the sector address Adr=0x01 of the memory bank BNK1 (W4). In parallel with it, the memory controller determines a ready/busy state of the memory bank BNK2 having the next sector (Adr=0x02), based on the ready/busy flag. When the memory controller detects the ready state, it outputs write data 2 for the sector Adr=0x02 to the flash memory 1. The flash memory 1 selects the operation of the memory bank BNK2 corresponding to the next sector address Adr=0x02, inputs or receives the write data (data 2) supplied from the memory controller in byte units, and sequentially stores the same in each individual data latch array of the data buffer 15 through the Y selector 14 (W5).

In a manner similar to the above, the flash memory 1 starts the operation of writing the latched data 2 into the corresponding sector at the sector address Adr=0x02 of the memory bank BNK2 following the input latch operation of the data 2 by the process W5 (W6). In parallel with it, the flash memory 1 selects the operation of the memory bank BNK3 corresponding to the next sector address Adr=0x03 and sequentially stores the next write data (data 3) into each data latch array of the data buffer 15 (W7).

In a manner similar to the above, the flash memory 1 starts the operation of writing the latched data 3 into the corresponding sector at the sector address Adr=0x03 of the memory bank BNK3 following the input latch operation of the data 3 by the process W7 (W8). In parallel with it, the flash memory 1 selects the operation of the memory bank BNK0 corresponding to the next sector address Adr=0x04 and sequentially stores the next write data (data 4) into each data latch array of the data buffer 15 (W9).

In a manner similar to the above, the flash memory 1 finally starts the operation of writing the latched data 4 into the corresponding sector at the sector address Adr=0x04 of the memory bank BNK0 following the input latch operation of the data 4 by the process W9 (W10). In parallel with it, the memory controller makes a decision about the ready/busy state of the memory bank BNK2 having the next sector (Adr=0x02), based on the ready/busy flag (status acquisition). In the present example, the writing of the data by the process W4 has not yet been completed, and the read state is detected after the completion of multiple decisions. Afterwards, the memory controller outputs write data 5 for the sector Adr=0x02 to the flash memory 1. The flash memory 1 selects the operation of the memory bank BNK2 corresponding to the sector address Adr=0x02, inputs the write data (data 2) supplied from the memory controller in byte units and sequentially stores the same into each data latch array of the data buffer 15 through the Y selector 14 (W11). The flash memory 1 starts the operation of writing the latched data 5 into the corresponding sector address Adr=0x05 of the memory bank BNK2 (W12). The memory controller is capable of detecting the completion of write operations for all the designated sectors, based on the ready/busy flag of the status register (status acquisition).

The CPU 8 performs, based on information about decoding by the command decoder 7, etc., the increment of each sector address with the leading sector address as a base or start point, and parallel control on both the operation of inputting write data to one memory bank and latching the same therein and the operation of writing latch data into each memory cell of the corresponding sector at other memory bank.

Upon execution of sequential write access to a plurality of sectors according to the sequential write access command with one write command WCMD2 as the head thereof, the operation of latching write data in one memory bank, and writing to each memory cell at other memory bank are executed in parallel, whereby sequential write access performance can be enhanced.

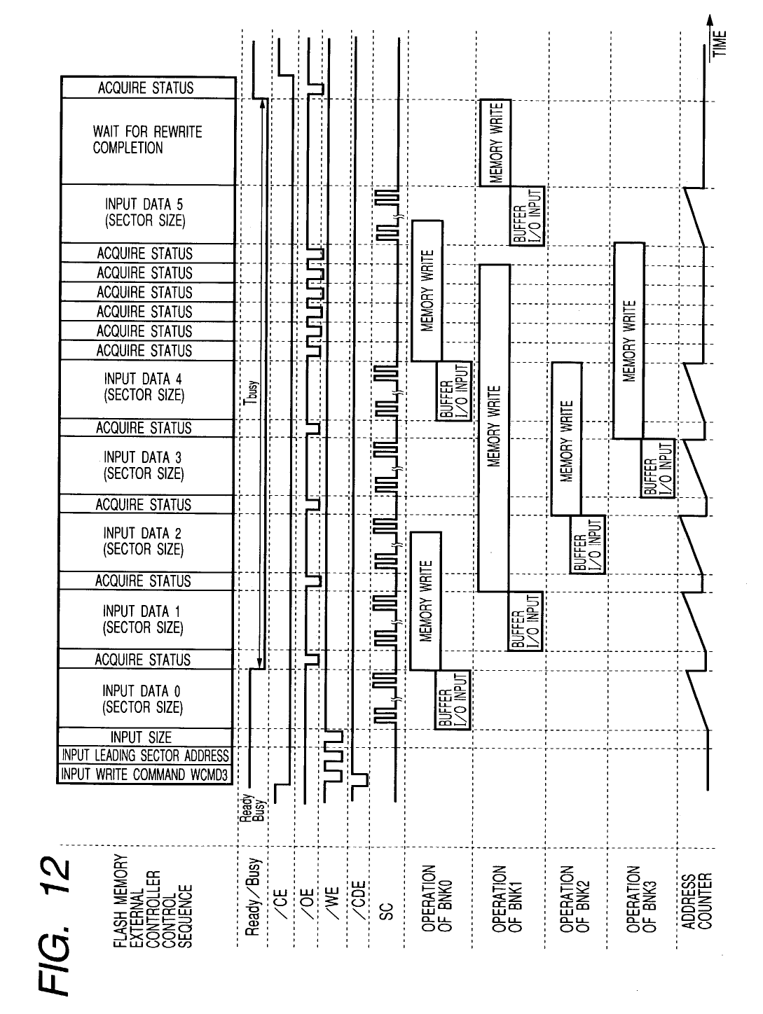

Another example of the sequential write access flow is shown in FIG. 12. A sequential write access command shown in FIG. 12 comprises a write command WCMD3, a leading sector address and the number of sectors, and write data corresponding to the number of the sectors. FIG. 12 is different from FIG. 11 in that the write start command WsCMD2 is not used. Count-up of the address counter 15 triggers the transition from the input latch operation of write data at one memory bank to the operation of writing of data into the corresponding sector. In brief, the input latch operation is transitioned to the operation of latching the write data in the corresponding data latch array of the data buffer 15 and thereafter automatically writing the latch data into the corresponding memory cell of each sector. This transition control is performed by detection of a count-up signal of the address counter 5 by the CPU 8. Other procedures are identical to those shown in FIG. 11. A processing time interval for the access flow of FIG. 11 can be shortened.

<<Sequential Rewrite Access Command>>

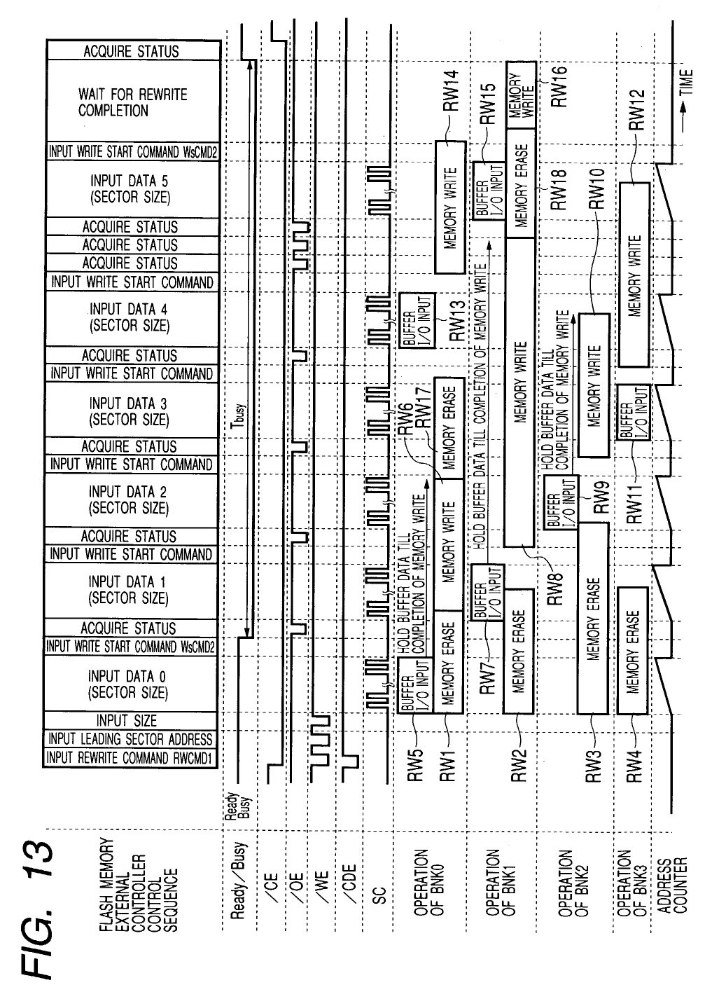

A sequential rewrite access flow is illustrated in FIG. 13. A sequential rewrite access command comprises a rewrite (reprogram) command RWCMD1, a leading sector address and the number of sectors, write data corresponding to the number of the sectors, and a write start command WsCMD2. FIG. 13 shows, as one example, a case in which the designated leading sector address is represented as Adr=0x00 in FIG. 5, the designated number of sectors is set as 6, and the six sectors Adr=0x00 through 0x05 shown in FIG. 5 are intended for rewrite (reprogram).

When the access subject (e.g., memory controller) issues the rewrite command RWCMD1, the leading sector address and the number of sectors to the flash memory 1, the flash memory 1 decodes the command to select four sectors (corresponding to the number of memory banks, i.e., four) from the leading sector address and starts erase operations for the objective sectors Adr=0x00 through 0x03 at the respective memory banks BNK0 through BNK3 (E1 through E4). In parallel with it, the memory bank BNK0 corresponding to the leading sector address Adr=0x00 inputs or receives write data (data 0) supplied form the memory controller in byte units and sequentially stores the same into each data latch array of the data buffer 15 through the Y selector 14 (RW5). A column selecting operation corresponding to one sector obtained by an increment operation of the address counter 5 carries out the operation of selecting the Y selector 14 at this time.

When the write start command WsCMD2 is issued from the memory controller following the input operation of the data 0 by the process RW5, the flash memory 1 decodes the command and starts the operation of writing the data 0 stored in each data latch array of the data buffer 15 at the process RW5 into the corresponding sector of the leading address Adr=0x00 of the memory bank BNK0 (RW6). In parallel with it, the memory controller determines a ready/busy state of the memory bank BNK1 having the next sector (Adr=0x01), based on the ready/busy flag. When the memory controller detects the ready state (data input ready state), it outputs write data 1 for the sector Adr=0x01 to the flash memory 1. The flash memory 1 selects the operation of the memory bank BNK1 corresponding to the next sector address Adr=0x01, inputs the write data (data 1) supplied from the memory controller in byte units, and sequentially stores the same in each individual data latch array of the data buffer 15 through the Y selector 14 (RW7). Incidentally, the memory bank BNK0 performs an erase operation for the sector Adr=0x04 for the purpose of the next writing after the write process RW6 (RW17).

When the write start command WsCMD2 is issued from the memory controller following the input operation of the data 1 by the process RW7, the flash memory 1 decodes the command and starts the operation of writing the data 1 stored in the corresponding data latch array of the data buffer 15 at the process RW7 into the corresponding sector of the sector address Adr=0x01 of the memory bank BNK1 (RW8). In parallel with it, the memory controller determines a ready/busy state of the memory bank BNK2 having the next sector (Adr=0x02), based on the ready/busy flag. When the memory controller detects the ready state, it outputs write data 2 for the sector Adr=0x02 to the flash memory 1. The flash memory 1 selects the operation of the memory bank BNK2 corresponding to the next sector address Adr=0x02, inputs or receives the write data (data 2) supplied from the memory controller in byte units, and sequentially stores the same in each individual data latch array of the data buffer 15 through the Y selector 14 (RW9). Incidentally, the memory bank BNK1 performs an erase operation for the sector Adr=0x05 for the purpose of the next writing after the write process RW8 (RW18).

In a manner similar to the above, the flash memory 1 starts the operation of writing the latched data 2 into the corresponding sector at the sector address Adr=0x02 of the memory bank BNK2 following the input latch operation of the data 2 by the process RW9 (RW10). In parallel with it, the flash memory 1 selects the operation of the memory bank BNK3 corresponding to the next sector address Adr=0x03 and sequentially stores the next write data (data 3) into each data latch array of the data buffer 15 (RW11).

In a manner similar to the above, the flash memory 1 starts the operation of writing the latched data 3 into the corresponding sector at the sector address Adr=0x03 of the memory bank BNK3 following the input latch operation of the data 3 by the process RW11 (RW12). In parallel with it, the flash memory 1 selects the operation of the memory bank BNK0 corresponding to the next sector address Adr=0x04 and sequentially stores the next write data (data 4) into each data latch array of the data buffer 15 (RW13).

In a manner similar to the above, the flash memory 1 finally starts the operation of writing the latched data 4 into the corresponding sector at the sector address Adr=0x04 of the memory bank BNK0 following the input latch operation of the data 4 by the process RW13 (RW14). In parallel with it, the memory controller makes a decision about the ready/busy state of the memory bank BNK2 having the next sector (Adr=0x02), based on the ready/busy flag (status acquisition). In the present example, the writing of the data by the process RW8 has not yet been completed, and the read state is detected after the completion of multiple decisions. Afterwards, the memory controller outputs write data 5 for the sector Adr=0x02 to the flash memory 1. The flash memory 1 selects the operation of the memory bank BNK2 corresponding to the sector address Adr=0x02, inputs the write data (data 5) supplied from the memory controller in byte units and sequentially stores the same into each data latch array of the data buffer 15 through the Y selector 14 (RW15). The flash memory 1 starts the operation of writing the latched data 5 into the corresponding sector address Adr=0x05 of the memory bank BNK2 following the input latch operation of the data by the process RW15 after the completion of the erase operation RW18 (RW16). The memory controller is capable of detecting the completion of write operations for all the designated sectors, based on the ready/busy flag of the status register (status acquisition).

The CPU 8 performs, based on information about decoding by the command decoder 7, etc., the increment of each sector address with the leading sector address as a base or start point, parallel control on both the operation of inputting write data to one memory bank and latching the same therein and the operation of writing latch data into each memory cell of the corresponding sector at other memory bank, and erase control parallel with the input latch operation of the write data.

According to the sequential rewrite access command with one rewrite command RWCMD1 as the head thereof, erase processes for a plurality of sectors are rendered parallel, an input latch operation and an erase process of write data at one sector are made parallel, and a latch operation of write data at one memory bank and writing to each memory cell at other memory bank are rendered parallel upon sequential write access to a plurality of sectors, whereby sequential rewrite access performance can be enhanced.

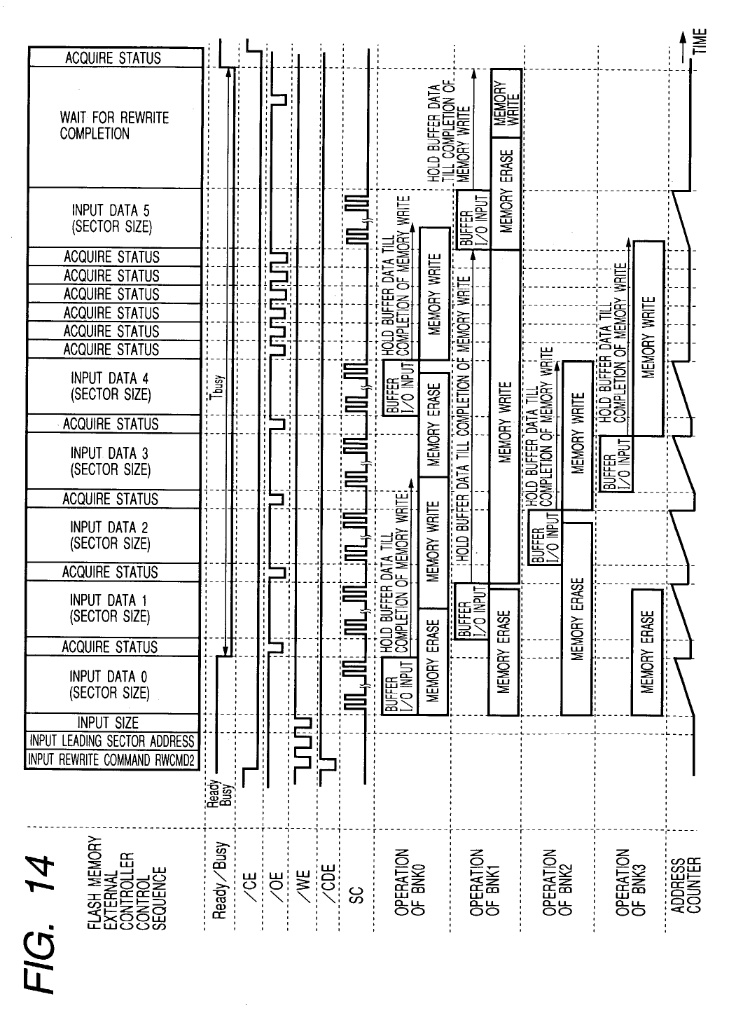

Another example of the sequential rewrite access flow is shown in FIG. 14. A sequential rewrite access command shown in FIG. 14 comprises a rewrite command RWCMD2, a leading sector address and the number of sectors, and write data corresponding to the number of the sectors. FIG. 14 is different from FIG. 13 in that the write start command WsCMD2 is not used. With count-up of the address counter 5 as a trigger, the CPU 8 controls the transition from the input latch operation of write data at one memory bank to the operation of writing of data into the corresponding sector. Other procedures are identical to those shown in FIG. 13. A processing time interval for the access flow of FIG. 13 can be shortened.

<<Memory Card>>

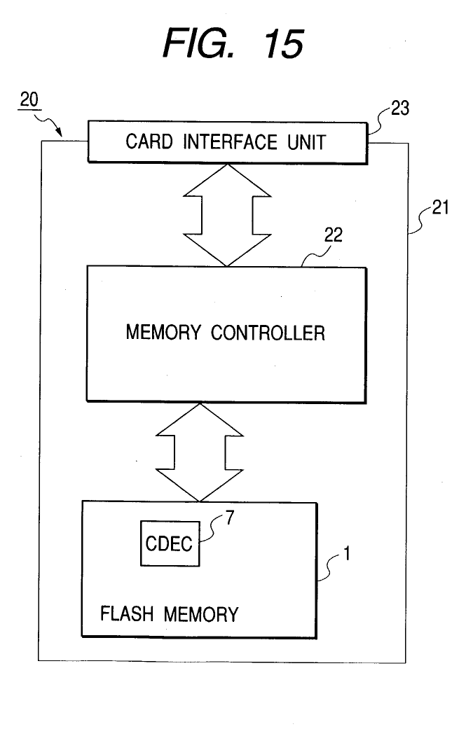

A memory card to which the flash memory 1 is applied, is illustrated in FIG. 15. The memory card 20 shown in the same drawing has the flash memory 1, a memory controller 22 capable of access-controlling the flash memory 1, and a card interface unit 23, which are provided on a card substrate 21. The memory card 20 is connected to a host device (not shown) through the card interface unit 23. In accordance with a file data access made from the host device, the memory controller 22 issues the commands RCMD1, ECMD1, WCMD, etc. constituting the single access command, and RCMD2, ECMD2, WCMD2, WCMD3, RWCMD1, RWCMD2, etc., constituting the sequential access command to thereby access-control the flash memory 1.

A configuration shown in FIG. 15 is based on the assumption that inherent command codes are respectively assigned to the commands RCMD1, ECMD1 and WCMD constituting the single access command, and RCMD2, ECMD2 and WCMD2 constituting the sequential access command. Thus, the command decoder 7 decodes an input command code as it is to perform operation control.

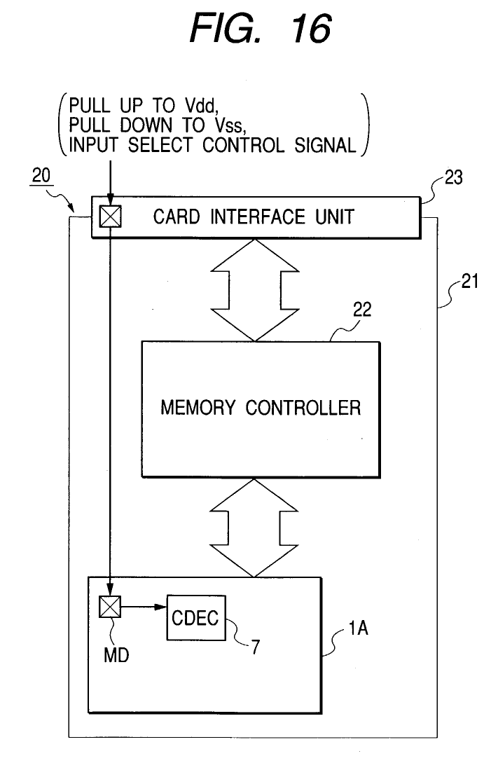

FIG. 16 illustrates a memory card 20 which has focused attention on a command-interpretation switching configuration where a flash memory 1A wherein the same command code is assigned to a single access command and a sequential access command, is used. In brief, instructing means for assigning the same command codes to correspondences between commands constituting the single access command and commands constituting the sequential access command corresponding to the single access command, e.g., individual pairs of RCMD1 and RCMD2, ECMD1 and ECMD2, and WCMD1 and WCMD2 and giving instructions as to interpretation-switching to the same command codes is adopted for the flash memory 1A without adopting the form that the sequential access command is newly added to the single access command. In FIG. 16, the instructing means is realized as an external terminal MD for inputting a mode signal used as command interpretation-switching information to a command decoder 7. The mode terminal MD is subjected to exclusive selection of pull-down to a circuit's ground voltage Vss or pull-up to a circuit's power supply voltage Vdd. Owing to its pull-down, the flash memory is capable of utilizing the sequential access command. The flash memory is capable of utilizing the single access command owing to its pull-up. The flash memory may receive a select control signal through a card interface unit 23. Other configurations of the flash memory 1A are identical to those shown in FIG. 1.

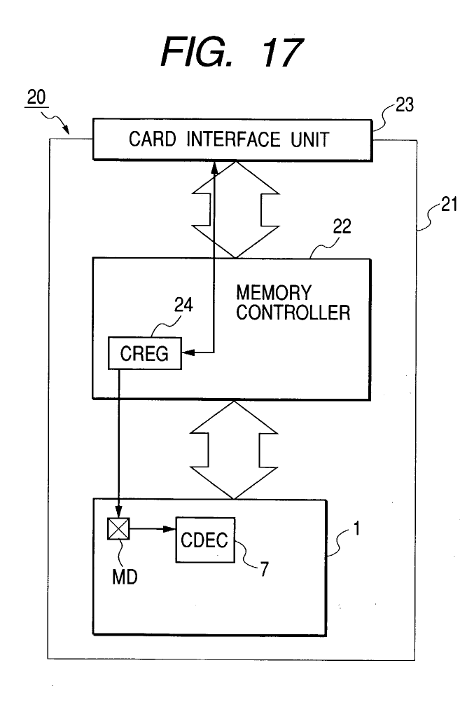

FIG. 17 illustrates another memory card which has focused attention on a command-interpretation switching configuration where a flash memory wherein the same command code is assigned to a single access command and a sequential access command, is used. A mode terminal MD is supplied with command interpretation-switching information about a logical value “1” or “0” set to a control register 24 of a memory controller 22. Owing to the setting of the logical value “0” thereto, the flash memory is capable of utilizing the sequential access command. Owing to the setting of the logical value “0” thereto, the flash memory is capable of utilizing the single access command. The control register 24 may be initially set by the operation of reset by a host system. Needless to say, it can be variably controlled by occasional changes in setting as an alternative to the above.

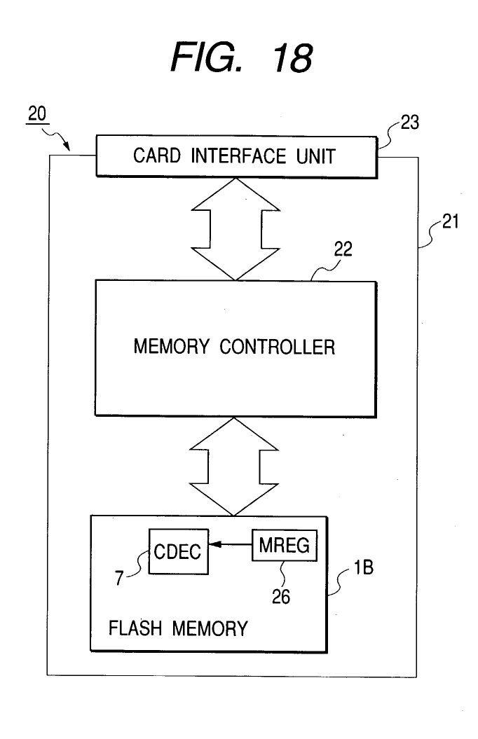

FIG. 18 illustrates a further memory card 20 which has focused attention on a command-interpretation switching configuration where a flash memory 1B wherein the same command code is assigned to a single access command and a sequential access command, is used. In the present memory card, the flash memory 1B is provided with a control register (MREG) 26 as instructing means for assigning the same command codes to correspondences between commands constituting the single access command and commands constituting the sequential access command corresponding to the single access command and giving instructions as to interpretation switching to the same command codes. Command interpretation-switching information about a logical value “1” or “0” set to the control register 26 is supplied to a command decoder 7. Owing to the setting of the logical value “0” thereto, the flash memory 1B is capable of utilizing the sequential access command. Owing to the setting of the logical value “1” thereto, the flash memory 1B is capable of utilizing the single access command. The control register 26 may be initially set by the operation of reset by a host system. Needless to say, it can be variably controlled by occasional changes in setting as an alternative to the above.

While the invention made above by the present inventors has been described specifically based on the illustrated embodiments, the present invention is not limited thereto. It is needless to say that various changes can be made thereto within the scope not departing from the substance thereof.

For instance, the nonvolatile memory is not limited to the flash memory. An MNOS, a ferroelectric memory cell, etc. may be used. Memory information for each memory cell is not limited to two values with respect to one memory cell and may adopt a multi value such as four values or the like. In the case of a multivalue-storable memory cell, multi-valued storage may be performed according to the difference in threshold voltage, or multi-valued storage may be carried out by locally storing electrical charges in storage gates. The configuration of each memory cell array of the flash memory is not limited to the AND type and may be suitably changed to a NOR type, a NAND type, etc. It is needless to say that the definition of the erasing and writing as considered on a threshold-voltage basis may be taken in reverse from the present specification.

Further, the type of command, the method of inputting write data, the number of parallel input bits and the like may be different from the above. Data, addresses and commands may be inputted from dedicated terminals respectively. The memory card is not limited to a multimedia card, a PC card and the like and is one which includes even an idea like a memory system configured as part of a data processing system configured with a microprocessor, a memory, etc. mounted on a circuit substrate.

Advantageous effects obtained by a typical one of the inventions disclosed in the present application will be described in brief as follows:

Upon sequential access to a plurality of write processing regions, the operation of latching write data in one memory bank and writing to each memory cell at other memory banks can be rendered parallel, the inward reading and external output of memory information at one memory bank can be made parallel, and erase processes for a plurality of memory banks can be rendered parallel.

Owing to the above, data access of a relatively large size can be made efficient. Sequential access performance where data of a size larger than a sector size defined as a write unit of each memory bank is handled, can be enhanced. Further, the speeding up of both data access of a size smaller than a sector size and data access of a size larger than the sector size can be realized.

What is claimed is:

1. A nonvolatile memory, comprising:
a plurality of memory banks having a plurality of erasable and programmable nonvolatile memory cells and capable of access-processing independently respectively,
wherein the nonvolatile memory has a first write operation mode in which a write instruction command, a write start address and the number of write processing regions with the write start address as a start point are inputted and thereafter write data and a write start command are capable of being sequentially received by the number of the write processing regions; writing to each memory cell is started in response to the write start command since the latching of write data for one write processing region in one memory bank; and a latch operation at one memory bank and writing to each memory cell at other memory banks can be made parallel.

2. The nonvolatile memory according to claim 1, including a second write operation mode in which write data is inputted after the input of a write instruction command and a write start address for one memory bank, and writing to each memory cell is capable of being started after write data has been latched in a write processing region designated by the write start address.

3. The nonvolatile memory according to claim 2, wherein the write instruction command of the first write operation mode and the write instruction command of the second write operation mode are different in command code from each other.

4. The nonvolatile memory according to claim 2,
wherein the write instruction command of the first write operation mode and the write instruction command of the second write operation mode are identical in command code,
wherein an instructing circuit for giving instructions as to interpretation switching to the same command codes is provided,
wherein the write instruction command is interpreted as instructions for the first write operation mode in a first state of the instructing circuit, and
wherein the write instruction command is interpreted as instructions for a second write operation mode in a second state of the instructing circuit.

5. The nonvolatile memory according to claim 1,
wherein the memory banks respectively have sectors each comprising nonvolatile memory cell columns, sector addresses are respectively assigned to the respective sectors, and the adjacent sector addresses are placed in mutually-different memory banks, and
wherein the write start address corresponds to the sector address and the number of the write processing regions corresponds to the number of sectors.

6. A nonvolatile memory, comprising:
a plurality of memory banks having a plurality of erasable and programmable nonvolatile memory cells and capable of access-processing independently respectively,
wherein the nonvolatile memory has a first write operation mode in which a write instruction command, a write start address and the number of write processing regions with the write start address as a start point are inputted and thereafter write data are capable of being sequentially received by the number of the write processing regions; writing to each memory cell is started since the latching of write data for one write processing region in one memory bank; and a latch operation at one memory bank and writing to each memory cell at other memory banks can be made parallel.

7. The nonvolatile memory according to claim 6, including a second write operation mode wherein write data is inputted after the input of a write instruction command and a write start address for one memory bank, and writing to each memory cell is capable of being started after write data has been latched in a write processing region designated by the write start address.

8. The nonvolatile memory according to claim 7, wherein the write instruction command of the first write operation mode and the write instruction command of the second write operation mode are different in command code from each other.

9. The nonvolatile memory according to claim 7,
wherein the write instruction command of the first write operation mode and the write instruction command of the second write operation mode are identical in command code,
wherein an instructing circuit for giving instructions as to interpretation switching to the same command codes is provided,
wherein the write instruction command is interpreted as instructions for the second write operation mode in a first state of the instructing circuit, and
wherein the write instruction command is interpreted as instructions for a third write operation mode in a second state of the instructing circuit.

10. A nonvolatile memory, comprising:
a plurality of memory banks having a plurality of erasable and programmable nonvolatile memory cells and capable of access-processing independently respectively,
wherein the nonvolatile memory has a first read operation mode in which a read instruction command, a read start address and the number of read processing regions with the read start address as a start point are inputted and thereafter data are capable of being read from the plurality of memory banks by the number of the read processing regions and outputted to the outside; an external output is started since the latching of data read from each memory cell for one read processing region in the corresponding memory bank; and a read and latch operation of data at one memory bank and the output of latch data to the outside at other memory banks can be made parallel.

11. The nonvolatile memory according to claim 10, including a second read operation mode in which after a read instruction command and a read start address for one memory bank have been inputted, data read from the corresponding read processing region designated by the read start address is capable of being latched and outputted to the outside.

12. The nonvolatile memory according to claim 11, wherein the read instruction command of the first read operation mode and the read instruction command of the second read operation mode are different in command code from each other.

13. The nonvolatile memory according to claim 11,
wherein the read instruction command of the first read operation mode and the read instruction command of the second read operation mode are identical in command code,
wherein an instructing circuit for giving instructions as to interpretation switching to the same command codes is provided,
wherein the read instruction command is interpreted as instructions for the first read operation mode in a first state of the instructing circuit, and
wherein the read instruction command is interpreted as instructions for the second read operation mode in a second state of the instructing circuit.

14. The nonvolatile memory according to claim 10,
wherein the memory banks respectively have sectors each comprising nonvolatile memory cell columns, sector addresses are respectively assigned to the respective sectors, and the adjacent sector addresses are placed in mutually-different memory banks, and
wherein the read start address corresponds to the sector address and the number of the read processing regions corresponds to the number of sectors.

15. A nonvolatile memory, comprising:
a plurality of memory banks having a plurality of erasable and programmable nonvolatile memory cells and capable of access-processing independently respectively,
wherein the nonvolatile memory has a first erase operation mode in which an erase instruction command, an erase start address, and the number of erase processing regions with the erase start address as a start point are inputted and thereafter erase processing regions of the plurality of memory banks are capable of being erased by the number of the erase processing regions; and an erase operation for the erase processing region at one memory bank and an erase operation for each erase processing region at other memory banks can be made parallel.

16. The nonvolatile memory according to claim 15, including a second erase operation mode in which after an erase instruction command and a sector address for one memory bank have been inputted, erasing is effected on each memory cell of a sector designated by the sector address.

17. The nonvolatile memory according to claim 16, wherein the erase instruction command of the first erase operation mode and the erase instruction command of the second erase operation mode are different in command code from each other.

18. The nonvolatile memory according to claim 16,
wherein the erase instruction command of the first erase operation mode and the erase instruction command of the second erase operation mode are identical in command code,
wherein an instructing circuit for giving instructions as to interpretation switching to the same command codes is provided,
wherein the erase instruction command is interpreted as instructions for the first erase operation mode in a first state of the instructing circuit, and
wherein the erase instruction command is interpreted as instructions for the second erase operation mode in a second state of the instructing circuit.

19. The nonvolatile memory according to claim 15,
wherein the memory banks respectively have sectors each comprising nonvolatile memory cell columns, sector addresses are respectively assigned to the respective sectors, and the adjacent sector addresses are placed in mutually-different memory banks, and
wherein the erase start address corresponds to the sector address and the number of the erase processing regions corresponds to the number of sectors.

20. A memory card, comprising:
a nonvolatile memory having a plurality of memory banks capable of access-processing independently respectively; and
a memory controller capable of access-controlling the nonvolatile memory,
said nonvolatile memory and said memory controller being structured on a card substrate,
wherein the memory controller is capable of outputting write data and a write start command by the number of write processing regions following a first write instruction command, a write start address and the number of the write processing regions with the write start address as a start point, and
wherein the nonvolatile memory latches write data for one write processing region in one memory bank in response to the first write instruction command and thereafter starts writing thereof to each memory cell in response to the write start command, and makes parallel a latch operation at one memory bank and writing to each memory cell at other memory banks.

21. The memory card according to claim 20, wherein the memory controller is capable of outputting a second write instruction command, a write start address, and write data, and
wherein the nonvolatile memory latches write data for a write processing region designated by the write start address in response to the second write instruction command and thereafter starts writing thereof to each memory cell.

22. The memory card according to claim 20,
wherein the memory controller is capable of outputting a first write instruction command, a write start address, and write data, and
wherein the nonvolatile memory inputs command interpretation-switching information,
latches write data for the corresponding write processing region designated by the write start address in response to the first write instruction command in a first state of the command interpretation-switching information and thereafter starts writing thereof to each memory cell,
latches write data for one write processing region in one memory bank in response to the first write instruction command in a second state of the command interpretation-switching information and thereafter starts writing thereof to each memory cell in response to the write start command, and
makes parallel a latch operation at one memory bank and writing to each memory cell at other memory banks.

23. A memory card, comprising:
a nonvolatile memory having a plurality of memory banks capable of access-processing independently respectively; and
a memory controller capable of access-controlling the nonvolatile memory,
said nonvolatile memory and said memory controller being structured on a card substrate,
wherein the memory controller is capable of sequentially outputting write data by the number of write processing regions following a first write instruction command, a write start address, and the number of the write processing regions with the write start address as a start point, and
wherein the nonvolatile memory latches write data for one write processing region in one memory bank in response to the first write instruction command and thereafter starts writing thereof to each memory cell, and makes parallel a latch operation at one memory bank and writing to each memory cell at other memory banks.

24. The memory card according to claim 23,
wherein the memory controller is capable of outputting a second write instruction command, a write start address, and write data, and
wherein the nonvolatile memory inputs command interpretation-switching information,
latches write data for the corresponding write processing region designated by the write start address in response to the first write instruction command in a first state of the command interpretation-switching information and thereafter starts writing thereof to each memory cell,
latches write data for one write processing region in one memory bank in response to the second write instruction command in a second state of the command interpretation-switching information and thereafter starts writing thereof to each memory cell, and
makes parallel a latch operation at one memory bank and writing to each memory cell at other memory banks.

25. A memory card, comprising:
a nonvolatile memory having a plurality of memory banks capable of access-processing independently respectively; and
a memory controller capable of access-controlling the nonvolatile memory,
said nonvolatile memory and said memory controller being structured on a card substrate,
wherein the memory controller is capable of outputting a first read instruction command, a read start address and the number of read processing regions with the read start address as a start point, and
wherein the nonvolatile memory is capable of reading data from the plurality of memory banks by the number of the read processing regions in response to the first read instruction command and outputting the same to the outside, latching data read from each memory cell for one read processing region at the corresponding memory bank and thereafter starting an external output thereof, and making parallel the operation of reading and latching data at one memory bank, and the external output of latch data at other memory banks.

26. The memory card according to claim 25,
wherein the memory controller is capable of outputting a second read instruction command, and a read start address, and
wherein the nonvolatile memory latches data read from the corresponding read processing region designated by the read start address in response to the second read instruction command and outputs the same to the outside.

27. The memory card according to claim 25,
wherein the memory controller is capable of outputting a first read instruction command and a read start address, and
wherein the nonvolatile memory inputs command interpretation-switching information,
latches data read from the corresponding read processing region designated by the read start address in response to the first read instruction command in a first state of the command interpretation-switching information and thereafter starts the output thereof to the outside, and
latches data read from each memory cell for one read processing region at the corresponding memory bank in response to the first read instruction command in a second state of the command interpretation-switching information and thereafter starts the output thereof to the outside, and makes parallel the operation of reading and latching data at one memory bank and the output of latch data at other memory banks to the outside.

28. A memory card, comprising:
a nonvolatile memory having a plurality of memory banks capable of access-processing independently respectively; and
a memory controller capable of access-controlling the nonvolatile memory,
said nonvolatile memory and said memory controller being structured on a card substrate,
wherein the memory controller is capable of outputting a first erase instruction command, an erase start address, and the number of erase processing regions with the erase start address as a start point, and
wherein the nonvolatile memory is capable of erasing erase processing regions for the plurality of memory banks by the number of the erase processing regions in response to the first erase instruction command and making parallel an erase operation for the corresponding erase processing region at one memory bank, and an erase operation for erase processing regions at other memory banks.

29. The nonvolatile memory according to claim 28,
wherein the memory controller is capable of outputting a second erase instruction command and an erase start address, and
wherein the nonvolatile memory effects erasing on each memory cell for the corresponding erase processing region designated by the erase start address in response to the second erase instruction command.

30. The memory card according to claim 28,
wherein the memory controller is capable of outputting a first erase instruction command and an erase start address, and
wherein the nonvolatile memory inputs command interpretation-switching information,
effects erasing on each memory cell for the corresponding erase processing region designated by the erase start address in response to the first erase instruction command in a first state of the command interpretation-switching information, and
enables erasure of erase processing regions of the plurality of memory banks by the number of the erase processing regions in response to the first erase instruction command in a second state of the command interpretation-switching information, and makes parallel an erase operation for the corresponding erase processing region at one memory bank and an erase operation for the corresponding erase processing region at other memory banks.

31. A nonvolatile memory, comprising:
a plurality of memory banks having a plurality of erasable and programmable nonvolatile memory cells and capable of access-processing independently respectively,
wherein the nonvolatile memory is capable of sequentially receiving write data and a write start command by the number of rewrite processing regions after a rewrite instruction command, a rewrite start address and the number of the rewrite processing regions with the rewrite start address as a start point are inputted, latching write data for one erased write processing region in one memory bank and thereafter starting writing thereof to each memory cell in response to the write start command, and making parallel a latch operation at one memory bank and writing to each memory cell at other memory banks.

32. A nonvolatile memory, comprising:
a plurality of memory banks having a plurality of erasable and programmable nonvolatile memory cells and capable of access-processing independently respectively,
wherein the nonvolatile memory is capable of sequentially receiving write data by the number of rewrite processing regions after a rewrite instruction command, a rewrite start address and the number of the rewrite processing regions with the rewrite start address as a start point are inputted, latching write data for one erased write processing region in one memory bank and thereafter starting writing thereof to each memory cell, and making parallel a latch operation at one memory bank and writing to each memory cell at other memory banks.
